(19) United States
(12) Patent Application Publication
(10) Pub. No.: US 2013/0100999 A1
(43) Pub. Date: Apr. 25, 2013

(54) SEMICONDUCTOR DEVICE

(71) Applicants: Yoshikazu Furuta, Kawasaki-shi (JP); Kazuaki Hori, Kawasaki-shi (JP); Yukinori Akamine, Chiyoda-ku (JP)

(72) Inventors: Yoshikazu Furuta, Kawasaki-shi (JP); Kazuaki Hori, Kawasaki-shi (JP); Yukinori Akamine, Chiyoda-ku (JP)

(73) Assignee: RENESAS ELECTRONICS CORPORATION, Kawasaki-shi, Kanagawa (JP)

(21) Appl. No.: 13/806,460

(22) PCT Filed: Jun. 22, 2010
(86) PCT No.: PCT/JP2010/060509

§ 371 Date: Dec. 21, 2012

(51) Int. Cl. H04B 1/40

(52) U.S. Cl. CPC H04B 1/40
USPC 375/219

(57) ABSTRACT

In a transmission portion of a semiconductor device, a first amplification portion receives a digital baseband signal and amplifies the signal with a first gain through digital processing. A digital-to-analog conversion portion converts the digital baseband signal amplified by the first amplification portion into an analog baseband signal. A modulation portion generates a transmission signal by modulating a local oscillation signal with the analog baseband signal. A second amplification portion amplifies the transmission signal with a variable second gain. A control unit receives information representing a transmission mode and adjusts the first gain in accordance with the transmission mode.

### RELATED APPLICATION

This application is the U.S. National Phase under 35 U.S.C. §371 of International Application No. PCT/JP2010/060509, filed on Jun. 22, 2010, the disclosure of which Application is incorporated by reference herein.

### TECHNICAL FIELD

This invention relates to a semiconductor device used in a transmission circuit of a radio communication apparatus.

### BACKGROUND ART

A radio communication apparatus such as a portable telephone is provided with a plurality of amplification circuits for amplifying a transmission signal having a radio frequency (RF) to desired output electric power. These amplification circuits are required to have a dynamic range sufficiently wide for a peak to average power ratio (PAPR) of a transmission signal, in order to suppress distortion of a transmission signal within the specifications. When a transmission signal having a high PAPR is input to an amplification circuit narrow in dynamic range, an output signal from the amplification circuit is distorted and hence an adjacent channel leakage ratio (ACLR) representing a ratio between electric power of a main signal channel and leaked electric power of an adjacent channel deteriorates.

A PAPR of a transmission signal closely relates to a modulation scheme and the number of multiplexed data channels, and in general, as a data transfer rate is higher, a PAPR becomes higher. Therefore, in order to suppress deterioration of an adjacent channel leakage ratio, back-off of an amplification circuit (difference between saturation output electric power and actual operating output electric power) should appropriately be adjusted in accordance with a modulation scheme and/or the number of multiplexed channels.

For example, in a communication apparatus described in WO2007/132916 (PTL 1), appropriate magnitude of back-off of a power amplification circuit is calculated by analyzing a waveform of a baseband signal. Based on calculated back-off, amplitude of an RF signal input to a power amplification circuit or supply electric power supplied from a power source to the power amplification circuit is controlled.

In a communication apparatus described in Japanese Patent Laying-Open No. 2007-27988 (PTL2), a maximum value of transmission electric power is controlled to be uniform among a plurality of modulation schemes. With such control, average electric power of a transmission signal will be a variable value different among the plurality of modulation schemes. In order to carry out such control, a gain of a variable gain amplification circuit is controlled in accordance with a signal designating a modulation scheme, which is input from a central processing unit (CPU).

In order to transmit a signal high in PAPR without distortion, a dynamic range of an amplification circuit is desirably as wide as possible. In order to expand a dynamic range of an amplification circuit, however, an operating current should be increased and hence current consumption by the amplification circuit increases. Japanese Patent Laying-Open No. 2007-5996 (PTL 3) discloses a communication apparatus capable of transmitting a signal without distortion in a high-speed communication mode in which a data transfer rate is relatively high and decreasing current consumption in an amplification circuit in a normal mode in which a data transfer rate is relatively low.

Specifically, in the communication apparatus in this document, an amplification circuit in a transmission portion is constituted of amplifiers connected in multiple stages. An amplifier in each stage is implemented by a linear amplifier of which gain is varied by an operating current. A baseband circuit supplies information on a transmission mode and information on the number of multiplexed data to an amplification circuit in the transmission portion. When the transmission mode changes from the normal mode to the high-speed communication mode or when the number of multiplexed data is increased, the amplification circuit increases an operating current in the amplifier in the last stage to thereby expand the dynamic range. With such an operation, the amplification circuit lowers a gain by decreasing an operating current in the amplifier in the preceding stage or in the first stage and adjusts distribution of gain of the amplifier in each stage such that gain is constant in the amplification circuit as a whole.

Unlike the method of adjusting gain of an amplification circuit as described in each document above, a method of lowering a PAPR through signal processing of a baseband signal is also available (see, for example, Japanese National Patent Publication No. 2009-535924 (PTL 4)).

### CITATION LIST

### Patent Literature

PTL 1: WO2007/132916
PTL 2: Japanese Patent Laying-Open No. 2007-27988
PTL 3: Japanese Patent Laying-Open No. 2007-5996
PTL 4: Japanese National Patent Publication No. 2009-535924

### SUMMARY OF INVENTION

### Technical Problem

In a portable radio communication apparatus such as a portable telephone, lower power consumption in the apparatus for saving a battery is an important issue. The technique described in Japanese Patent Laying-Open No. 2007-5996 (PTL 3) above is a promising technique in terms of this lower power consumption, however, it is disadvantageous in noise characteristics because an amplification circuit is constituted of linear amplifiers connected in multiple stages. Namely, if an amplification circuit is constituted of multiple stages, an amplifier in a subsequent stage amplifies noise in an amplifier in a preceding stage and thus noise characteristics of the amplification circuit as a whole deteriorate. In the case of a high-speed communication mode higher in data transfer rate than the normal mode, noise characteristics further deteriorate. In this case, by increasing an operating current of the amplifier in the last stage, a gain and a dynamic range are increased, and by decreasing an operating current of the amplifier in the first stage, the gain is decreased. Thus, noise characteristics of the amplifier in the first stage become poorer than in the normal mode and noise characteristics of the amplification circuit as a whole deteriorate.

In a third-generation (3G) mobile communication system such as W-CDMA (Wideband Code Division Multiple Access) or UMTS (Universal Mobile Telecommunications System), frequency division duplex (FDD) is employed for communication between a base station and a mobile station. Therefore, a reception portion and a transmission portion simultaneously operate in a mobile station (a portable telephone). Therefore, when noise in the transmission portion is great, noise should be suppressed in the reception portion by providing a surface acoustic wave (SAW) filter or the like and a problem of increase in cost also arises.

This invention was made in consideration of the problems above. An object of this invention is to provide a semiconductor device for communication, capable of adjusting a gain of an amplification circuit and lowering power consumption in accordance with a PAPR of a transmission signal and achieving improved noise characteristics as compared with a conventional example.

### Solution to Problem

A semiconductor device according to one embodiment of this invention includes a first amplification portion, a digital-to-analog conversion portion, a modulation portion, a second amplification portion, and a control unit. The first amplification portion receives a first digital baseband signal and generates a second digital baseband signal by amplifying this first digital baseband signal with a first gain. The digital-to-analog conversion portion converts the second digital baseband signal into an analog baseband signal. The modulation portion generates a transmission signal by modulating a local oscillation signal with the analog baseband signal. The second amplification portion amplifies the transmission signal with a variable second gain. This semiconductor device is capable of transmitting data in accordance with each of a plurality of transmission modes, and the control unit receives information representing any of the transmission modes and adjusts the first gain in accordance with the transmission mode.

### Advantageous Effects of Invention

According to the embodiment above, by providing a first amplification portion in a stage preceding the digital-to-analog conversion portion and adjusting amplitude of a digital baseband signal, a gain and power consumption of the second amplification portion can be adjusted in accordance with a PAPR and noise characteristics can be improved as compared with a conventional example.

### BRIEF DESCRIPTION OF DRAWINGS

FIG. 1 is a block diagram showing a configuration of a radio communication system 1 according to an embodiment of this invention.

FIG. 2 is a block diagram showing a specific configuration of a front end module 12 in FIG. 1.

FIG. 3 is a waveform diagram of a transmission signal in each transmission scheme.

FIG. 4 is a diagram showing one example of gain characteristics of a transmission circuit.

FIG. 5 is a diagram showing relation between gain of an RFPGA and an operating current.

FIG. 6 is a block diagram showing a detailed configuration of a transmission portion 22 and an HPA module 11 in FIG. 1.

FIG. 7 is a diagram showing one example of a configuration of a DPGA 24.

FIG. 8 is a diagram showing one example of a configuration of an RFPGA 35.

FIG. 9 is a block diagram showing a configuration of an APC 36.

FIG. 10 is a diagram schematically showing an example of one certain table stored in a gain setting portion 57.

FIG. 11 is a diagram schematically showing an exemplary table corresponding to a transmission mode different from that in FIG. 10, which is stored in gain setting portion 57.

FIG. 12 shows an exemplary table corresponding to temperature information and frequency information different from that in FIG. 10, in an LTE mode or an HSUPA mode.

FIG. 13 shows an exemplary table corresponding to temperature information and frequency information different from that in FIG. 11, in an R99 mode.

FIG. 14 is a block diagram showing a configuration of a transmission portion 122 according to a second embodiment of this invention.

### DESCRIPTION OF EMBODIMENTS

An embodiment of this invention will be described hereinafter in detail with reference to the drawings. It is noted that the same or corresponding elements have the same reference characters allotted and description thereof will not be repeated.

### First Embodiment

[Schematic Configuration of Radio Communication System]

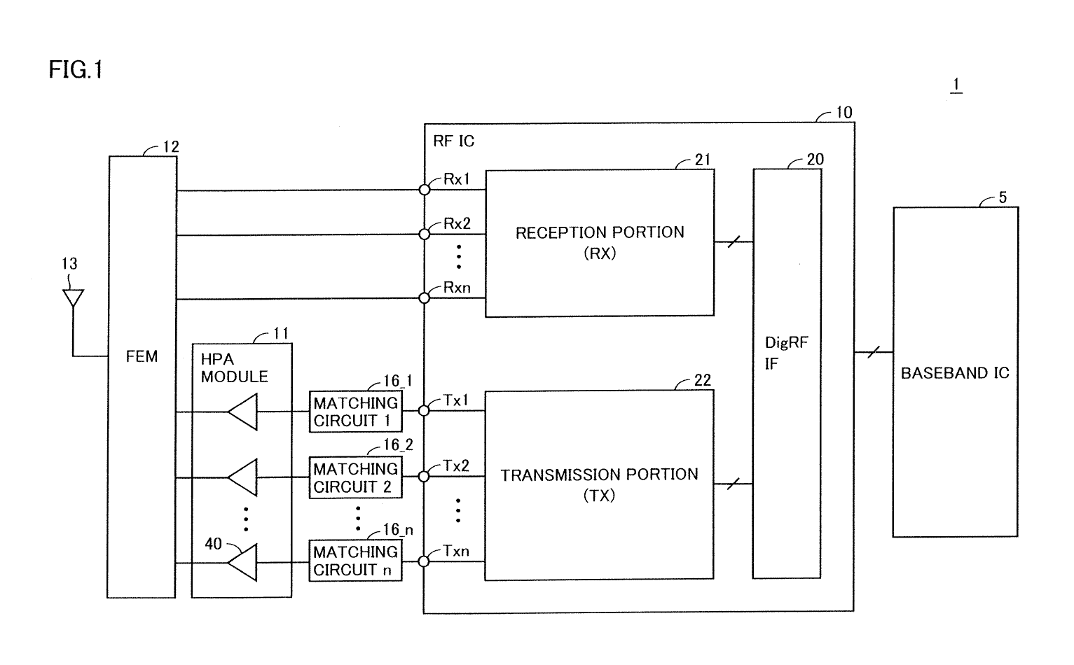

FIG. 1 is a block diagram showing a configuration of a radio communication system 1 according to an embodiment of this invention. Radio communication system 1 in FIG. 1 is contained in a portable telephone. Radio communication system 1 includes an RFIC (Radio-Frequency Integrated Circuit) 10, a baseband IC (Integrated Circuit) 5, an HPA (High Power Amplifier) module 11, matching circuits 16_1 to 16_{—}n, a front end module (FEM) 12, and an antenna 13.

(RFIC)

RFIC 10 is a 1-chip transceiver IC (a semiconductor integrated circuit for communication) allowing transmission and reception of an RF (Radio-Frequency) signal with a base station through an antenna, in conformity with the standards of three broadly-categorized transmission and reception schemes of “GSM/EDGE”, “WCDMA/HSPA”, and “LTE”.

Here, GSM (Global System for Mobile Communication) is second-generation (2G) portable telephone standards realized in a TDD (Time Division Duplex)-TDMA (Time Division Multiple Access) scheme. EDGE (Enhanced Data Rates for GSM Evolution) is extended standards for packet communication among GSM schemes. In EDGE, 8PSK (8 Phase Shift Keying) is employed as a digital modulation scheme.

WCDMA (Wideband Code Divided Multiple Access) is third-generation (3G) portable telephone standards realized in an FDD (Frequency Division Duplex)-CDMA (Code Division Multiple Access) scheme, and known as UMTS (Universal Mobile Telecommunications Systems) in Europe and America. HSPA (High Speed Packet Access) is extended standards for high-speed packet communication in WCDMA and particularly called 3.5G portable telephone standards.

LTE (Long Term Evolution) is portable telephone standards for achieving a higher speed and a broader bandwidth than HSPA and called 3.9G portable telephone standards. In LTE, OFDMA (Orthogonal Frequency Division Multiple Access) is adopted for downstream communication, and SC-FDMA (Single Carrier Frequency Division Multiple Access) is adopted for upstream communication.

RFIC 10 has a reception portion (RX) 21, a transmission portion (TX) 22, and a digital RF interface (DigRF IF).

Reception portion 21 down-converts a reception RF signal from a base station received at antenna 13 into an analog reception baseband signal by using a local carrier signal (a local oscillation signal). Reception portion 21 generates a digital reception baseband signal through further AD (Analog-to-Digital) conversion of the analog reception baseband signal.

In contrast, transmission portion 22 transmits an analog transmission baseband signal through DA (Digital-to-Analog) conversion of a digital transmission baseband signal and up-converts the analog transmission baseband signal to a transmission RF signal by using a local carrier signal. Then, transmission portion 22 transmits by radio the transmission RF signal to the base station through antenna 13.

A digital RF interface 20 is an interface between RFIC 10 and baseband IC 5, and it complies with interface standards developed by MIPI (Mobile Industry Processor Interface) Alliance.

RFIC 10 further has a plurality of output terminals Tx1 to Txn each for outputting an RF signal and a plurality of input terminals Rx1 to Rxn each for receiving an RF signal. An output terminal and an input terminal are paired as (Tx1, Rx1), (Txn, Rxn), and a pair of an output terminal and an input terminal to be used is determined in accordance with a band (a frequency band) in which the RFIC is used.

(Baseband IC)

Baseband IC 5 subjects a digital reception baseband signal received from RFIC 10 to digital demodulation and other signal processing corresponding to each of the three transmission and reception modes, and generates reception data (audio, image, or other data). Baseband IC 5 further subjects transmission data (audio, image, or other data) to digital modulation and other signal processing corresponding to each of the three transmission and reception modes to thereby generate a digital transmission baseband signal and transfer the signal to RFIC 10. Though not illustrated in FIG. 1, a portable telephone on which radio communication system 1 is mounted has an application processor, a memory, a speaker, a microphone, an input key, and a liquid crystal monitor, and each exchanges a signal with baseband IC 5.

(HPA Module)

HPA module 11 has a plurality of HPAs (High Power Amplifiers) 40 provided in correspondence with output terminals Tx1 to Txn, respectively. Each HPA 40 amplifies a transmission RF signal received through a matching circuit from a corresponding output terminal. Each HPA 40 is implemented by a single semiconductor chip and the HPAs are modularized in a package. Matching circuits 16_1 to 16_{—}n are inserted between output terminals Tx1 to Txn and a plurality of HPAs 40, respectively. Though matching circuit 16_1. 16_2 is externally attached to RF-IC 10 in FIG. 1, it may also be contained in RF-IC 10.

(Front End Module)

Front end module 12 selects one of input and output terminal pairs (Rx1, Tx1) to (Rxn, Txn), and connects the selected input and output terminal pair (Rxi, Txi) (i being an integer not smaller than 1 and not greater than n) and antenna 13 to each other.

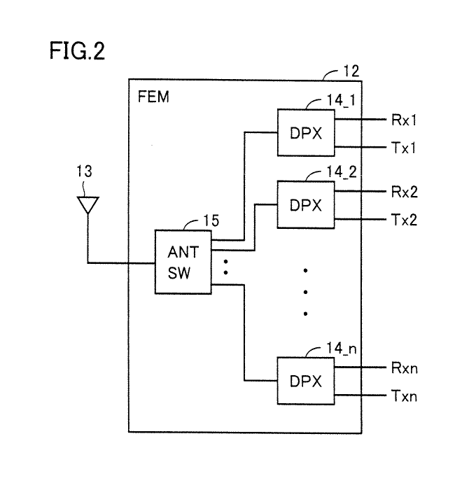

FIG. 2 is a block diagram showing a specific configuration of front end module 12 in FIG. 1. Referring to FIGS. 1 and 2, front end module 12 includes an antenna switch (ANT SW) 15 and a plurality of duplexers (DPX) 14_1 to 14_{—}n (denoted as a duplexer 14 when an unspecified one is indicated) corresponding to the input and output terminal pairs (Rx1, Tx1) to (Rxn, Txn), respectively.

Antenna switch 15 selects one duplexer 14 in accordance with a frequency band to be used and connects selected duplexer 14 and antenna 13 to each other. Selected duplexer 14 transmits a transmission RF signal from corresponding output terminal Txi (i being an integer not smaller than 1 and not greater than n) to antenna 13 and at the same time, it transmits a reception RF signal from antenna 13 to corresponding input terminal Rxi. Here, duplexer 14 suppresses leakage of a transmission RF signal to input terminal Rxi and suppresses leakage of a reception RF signal to output terminal Txi. Thus, the FDD scheme is realized in transmission and reception to and from a base station. Antenna switch 15 and each of the plurality of duplexers 14_1 to 14_{—}n are each implemented by a single semiconductor chip, and these are modularized in a single package.

[Problems of Conventional Transmission Portion]

Transmission portion 22 described with reference to FIG. 1 includes a circuit portion carrying out 2G-based GSM/EDGE transmission and a circuit portion carrying out transmission in accordance with the three 3G-based transmission schemes (transmission modes). The 3G-based transmission schemes are specifically as follows, and they are different from one another in modulation scheme, multiplexing scheme, and multiple access scheme. Here, the “multiplexing scheme” refers to a scheme with which a plurality of pieces of information (data) transmitted by one user are multiplexed for transmission and “multiple access” refers to a scheme with which respective pieces of information (data) transmitted by a plurality of users at different locations are multiplexed for transmission.

(i) Release 99 (hereinafter abbreviated as “R99”): A normal mode in WCDMA, of which modulation scheme is QPSK (Quadrature Phase Shift Keying), multiplexing scheme is CDM (Code Division Multiplexing), and multiple access scheme is CDMA.

(ii) HSUPA (High Speed Uplink Packet Access): Uplink high-speed packet communication standards for HSPA, using any of QPSK (Quadrature Phase Shift Keying) and 16QAM (16 Quadrature Amplitude Modulation) in accordance with a radio wave condition. The 16QAM is capable of carrying information of 4 bits (16 values) per 1 symbol, and it achieves a transmission rate twice as high as that of QPSK. The multiplexing scheme is CDM and the multiple access scheme is CDMA.

(iii) LTE: Any of QPSK, 16QAM, and 64QAM is used in accordance with a radio wave condition. The multiplexing scheme is SC-FDE (Single Carrier Frequency Domain Equalization) and the multiple access scheme is SC-FDMA.

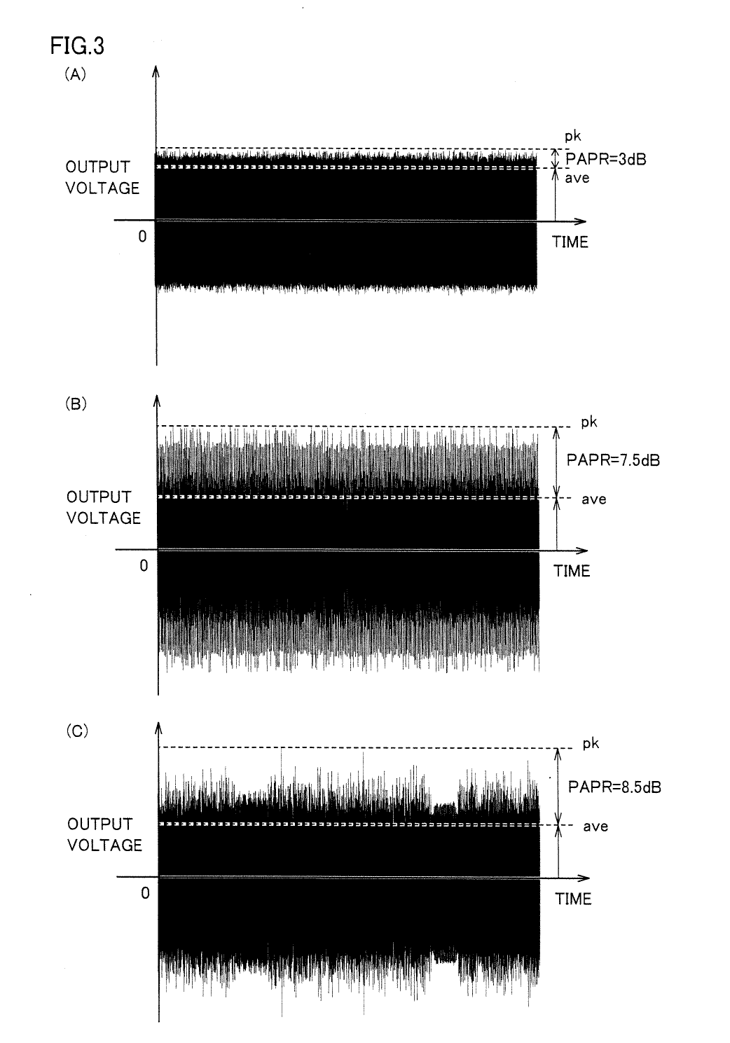

FIG. 3 is a waveform diagram of a transmission signal in each transmission scheme. FIG. 3(A) shows one example of a transmission waveform in the case of the R99, FIG. 3(B) shows one example of a transmission waveform in the case of the HSUPA, and FIG. 3(C) shows one example of a transmission waveform in the case of the LTE. It is noted that the case where the modulation scheme is 16QAM is shown for the HSUPA and the LTE. In FIGS. 3(A) to 3(C), positions of an average voltage ave and a peak value pk are shown with dashed lines.

A peak to average power ratio (PAPR) of a transmission signal increases or decreases in accordance with the modulation scheme and the number of multiplexed data. In the LTE scheme, further depending on the number of assigned RBs (Resource Blocks), a PAPR of a transmission signal varies. Consequently, as shown in FIGS. 3(A) to (C), in the case of the R99, the PAPR of a transmission signal is approximately 3 dB, whereas in the case of the HSUPA, the PAPR of a transmission signal increases approximately to 7.5 dB and in the case of the LTE, the PAPR of a transmission signal increases to approximately 8.5 dB.

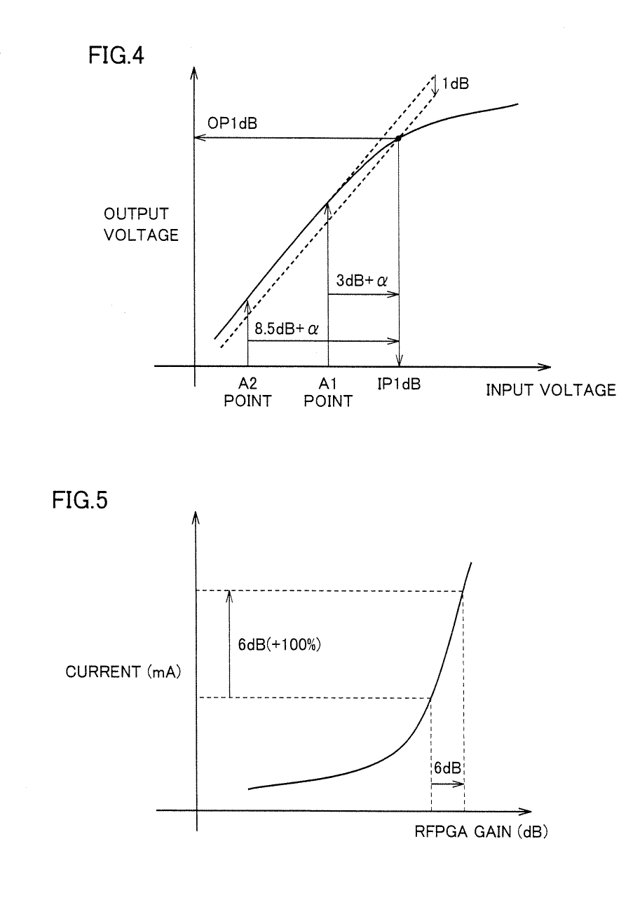

FIG. 4 is a diagram showing one example of gain characteristics of a transmission circuit. In mobile radio communication, restriction on out-of-band radiant electric power is strict and a transmission circuit is required to have high linearity. In general, P1 dB (1 dB Compression point) represents an indicator indicating linearity of a circuit. As shown in FIG. 4, an input level lower in gain by 1 dB than ideally linear gain characteristics is referred to as IP1 dB (Input P1 dB) and an output level is referred to as OP1 dB (Output P1 dB). P1 dB is normally evaluated in terms of a CW wave (Continuous wave). When a signal having large amplitude is input to a circuit having non-linear distortion, out-of-band spectral radiation attributed to non-linear distortion of a circuit takes place. Out-of-band spectral radiation that took place leaks to an adjacent channel and becomes an interference wave with the adjacent channel. Therefore, in order to transmit a signal without distortion, a signal having an average voltage of the circuit lower approximately by PAPR than P1 dB is input to the circuit such that the circuit can achieve linear amplification even at maximum amplitude of the input signal. In the case where P1 dB of the transmission circuit is not varied, an effective value of an input voltage when the transmission mode is set to the R99 attains to an A1 point in FIG. 4 and an effective value of an input voltage when the transmission mode is set to the LTE attains to an A2 point in FIG. 4.

In general, a block highest in current consumption in a transmission portion is an RF amplification circuit in an output stage of the RF portion and it requires a higher operating current, because high linearly is required in a later stage. Since a control range of transmission electric power is wide in particular in the case of a transmitter adapted to the UMTS/LTE scheme, current consumption in an RF programmable gain amplification circuit (PGA) is great.

FIG. 5 is a diagram showing relation between gain of an RFPGA and an operating current. In general, in an RFPGA, in order to vary the gain in a linear-in-dB manner, an operating current should exponentially be increased with respect to gain. For example, in FIG. 5, current consumption at the time when the gain is increased by 6 dB is doubled.

In a transmission circuit handling a plurality of signals different in PAPR from one another, in an attempt to be able to amplify any input signal without distortion, a circuit should be designed so as to have linearity with sufficient margin for a signal having a highest PAPR. If a programmable gain amplification circuit in the RF portion is designed as such, a current consumed in a transmission circuit becomes constantly great regardless of a PAPR of an input signal, which disadvantageously shortens a time period of drive of a battery of a portable terminal.

In RFIC 10 in the first embodiment, a digital programmable gain amplifier is provided in a stage preceding a digital-to-analog converter, so that power consumption in an amplification circuit can be decreased and noise characteristics can be improved, as will be described below in detail.

[Detailed Configuration of Transmission Portion]

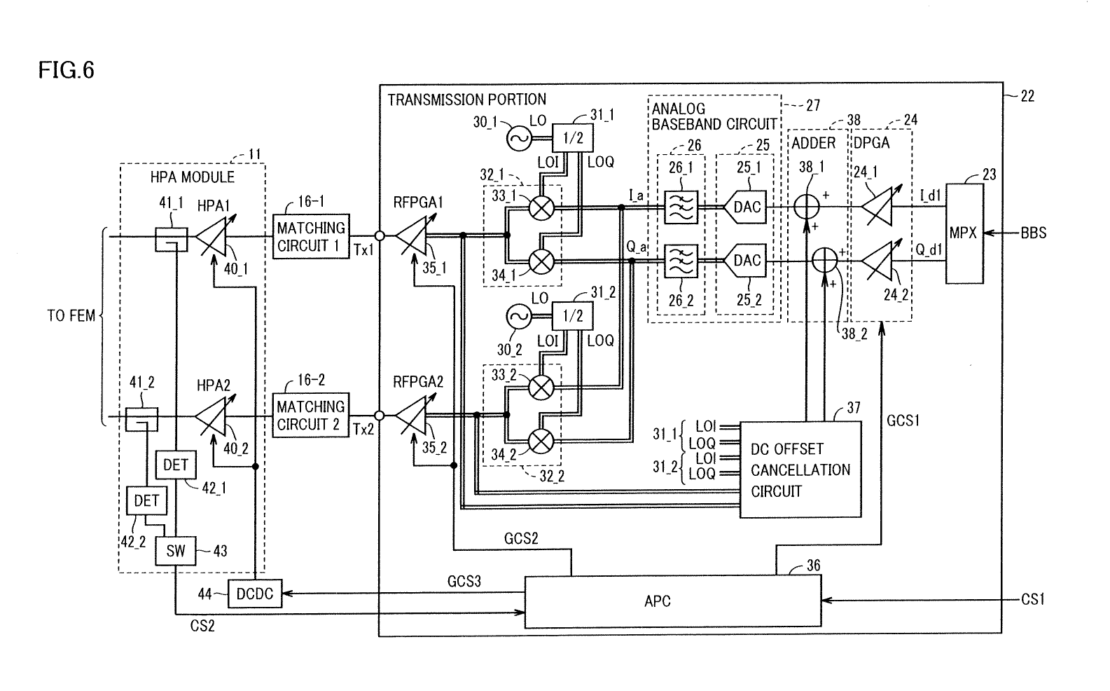

FIG. 6 is a block diagram showing a detailed configuration of transmission portion 22 and HPA module 11 in FIG. 1.

Transmission portion 22 receives a digital transmission baseband signal generated by baseband IC 5 in FIG. 1 in accordance with each transmission mode through digital RF interface 20 in FIG. 1. Transmission portion 22 generates an RF signal by up-converting the received digital transmission baseband signal with a direct conversion scheme.

Transmission portion 22 is capable of generating an RF signal in a plurality of frequency bands within a range from 800 MHz to 2.5 GHz. The frequency band is determined by the standards, and “Band1”, “Band2”, and “Band1”' are representatively used. “Band1” is a band from 1920 MHz to 1980 MHz, “Band2” is a band from 1850 MHz to 1910 MHz, and “Band7” is a band from 2500 MHz to 2570 MHz.

Referring to FIG. 6, transmission portion 22 includes a multiplexer (MPX) 23, two digital programmable gain amplifiers (DPGA) 24_1, 24_2, two adders 38_1, 38_2, two digital-to-analog converters (DAC) 25_1, 25_2, low pass filters (LPF) 26_1, 26_2, and an automatic power controller (APC) 36. DAC 25 (25_1, 25_2) and low pass filter 26 (26_1, 26_2) constitute an analog baseband circuit 27. Each component will be described below.

(Multiplexer)

A digital transmission baseband signal (transmission data) received from baseband IC 5 through digital RF interface 20 includes such a 1-bit data signal that an in-phase component signal (I signal) and a quadrature component signal (Q signal) are serially transferred. With this 1-bit data signal, the digital transmission baseband signal further includes a 1-bit clock signal with which the 1-bit data signal is in synchronization and a 1-bit enable signal permitting data to be taken in.

Multiplexer 23 separates (multiplexes) the I signal and the Q signal that have serially been transferred and converts each of the serial I signal and Q signal to a parallel signal (an I signal I_d1, a Q signal Q_d1) consisting of a plurality of bits.

(DPGA)

DPGAs 24_1, 24_2 (also referred to as DPGA 24 when they are collectively referred to) are amplifiers of which gain is variable. DPGA 24_1 amplifies I signal I_d1 which is a parallel digital signal through digital processing. Namely, DPGA 24_1 converts a value of I signal I_d1 into a value obtained by multiplying I signal I_d1 by gain. Similarly, DPGA 24_2 amplifies Q signal Q_d1 which is a parallel digital signal through digital processing. Gain (also referred to as an amplification factor) of each DPGA is adjusted based on a gain adjustment signal GCS1. Here, the gain is adjusted such that two DPGAs 24_1, 24_2 have the same gain. For example, in the case where gain adjustment signal GCS1 is a signal indicating adjustment of gain to 1 dB, the gain of each of two DPGAs 24_1, 24_2 is adjusted to 1 dB. Gain adjustment signal GCS1 is supplied from APC 36.

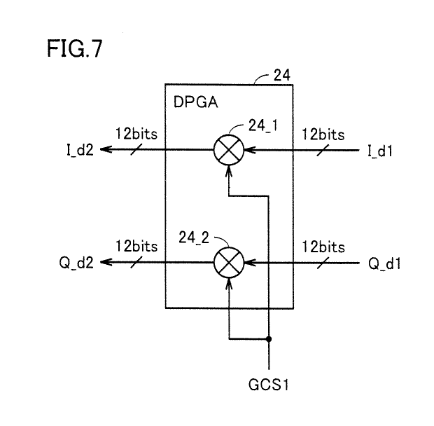

FIG. 7 is a diagram showing one example of a configuration of DPGA 24. Referring to FIG. 7, DPGA 24_1 is a digital multiplier for outputting a value obtained by multiplying I signal (digital signal) I_d1 from multiplexer 23 by gain adjustment signal GCS1 from APC 36. DPGA 24_2 is a digital multiplier for outputting a value obtained by multiplying Q signal (digital signal) Q_d1 from multiplexer 23 by gain adjustment signal GCS1 from APC 36. Values multiplied in DPGAs 24_1, 24_2 become signals (digital signals) I_d2, Q_d2 obtained by amplifying I signal I_d1 and Q signal Q_d1 with gain set by APC 36, respectively, and they are sent to analog baseband circuit 27 in the next stage.

Though DPGA 24_1, 24_2 is implemented by a multiplier in FIG. 7, a look up table may be employed instead of a multiplier. In a look up table, a value to be output in correspondence with input I signal I_d1 and Q signal Q_d1 and given gain (a value obtained by multiplying a value of I signal I_d1 and Q signal Q_d1 by gain) is prepared in advance. The respective DPGAs output signals I_d2, Q_d2 obtained by multiplying I signal I_d1 and Q signal Q_d1 by gain, by referring to the look up table. (DAC, Low Pass Filter)

Referring again to FIG. 6, amplified digital I signal and Q signal output from DPGAs 24_1, 24_2 are input to adders 38_1, 38_2 (also referred to as adder 38 when they are collectively referred to), respectively. Adder 38_1, 38_2 adds a correction signal for correcting DC offset output from a DC offset cancellation circuit 37 which will be described later to the digital I signal, Q signal.

DAC 25_1 converts the digital I signal output from adder 38_1 into a differential analog signal. A frequency range higher than a cut-off frequency in an analog I signal output from DAC 25_1 is removed by low pass filter 26_1. Similarly, DAC 25_2 converts the digital Q signal output from adder 38_2 into a differential analog signal. A frequency range higher than a cut-off frequency in an analog Q signal output from DAC 25_2 is removed by low pass filter 26_2.

(Local Oscillator, ½ Frequency Divider, and Quadrature Modulator)

Transmission portion 22 further includes a plurality of local oscillators 30 (30_1, 30_2), a plurality of ½ frequency dividers 31 (31_1, 31_2), a plurality of quadrature modulators 32 (32_1, 32_2), and a plurality of radio frequency programmable gain amplifiers (RFPGA) 35 (35_1, 35_2) (denoted as local oscillator 30, ½ frequency divider 31, quadrature modulator 32, and RFPGA 35, respectively, when they are collectively referred to or when an unspecified one is indicated). Local oscillator 30, ½ frequency divider 31, quadrature modulator 32, and RFPGA 35 are in principle provided in correspondence with a frequency band in each transmission mode, however, in the case of proximate frequency bands, they may be shared by different frequency bands. Though FIG. 6 shows two of each component as representatives, the number of components is not actually limited to two.

Local oscillator 30 generates a differential local oscillation signal (a clock signal identical in frequency and different in phase by 180 degrees) LO.

The ½ frequency divider 31 generates local oscillation signals LOI, LOQ obtained by dividing a frequency of local oscillation signal LO into ½. Local oscillation signal LOI is in synchronization with a rising edge of original signal LO and local oscillation signal LOQ is in synchronization with a falling edge of original signal LO. Thus, local oscillation signal LOQ is a signal shifted in phase by 90 degrees from local oscillation signal LOI.

Quadrature modulator 32 receives local oscillation signals LOI, LOQ output from corresponding ½ frequency divider 31 and analog I signal I_a and Q signal Q_a output from respective low pass filters 26_1, 26_2. Quadrature modulator 32 carries out quadrature modulation of local oscillation signals LOI, LOQ with I signal I_a, Q signal Q_a, to thereby generate an analog transmission RF signal obtained by up-converting I signal I_a, Q signal Q_a to a frequency of local oscillation signals LOI, LOQ. More specifically, quadrature modulator 32 includes a mixer 33 for mixing local oscillation signal LOT and I signal I_a and a mixer 34 for mixing local oscillation signal LOQ and Q signal Q_a. Outputs from these mixers 33, 34 are added and output to RFPGA 35 in the next stage as a transmission RF signal.

In accordance with a frequency band of a signal to be transmitted by the RFIC, quadrature modulator 32 for up-conversion is selectively used. It is assumed that illustrated quadrature modulator 32_1 carries out up-conversion to a high frequency band (Band1) exceeding 2,000 MHz, and quadrature modulator 32_2 carries out up-conversion to a plurality of frequency bands (for example, Band1, Band2) not higher than 2,000 MHz. The plurality of quadrature modulators 32 exclusively operate. Namely, while one quadrature modulator corresponding to a frequency band used by the RFIC operates, other quadrature modulators do not operate.

(RFPGA)

RFPGAs 35_1, 35_2 are provided in correspondence with respective quadrature modulators 32_1, 32_2. RFPGA 35 is a variable gain amplifier for amplifying a transmission RF signal output from corresponding quadrature modulator 32, and performs an amplification operation when corresponding quadrature modulator 32 operates. When one RFPGA corresponding to a frequency band used by the RFIC operates, other RFPGAs do not operate. Gain of RFPGA 35 is adjusted based on a gain adjustment signal GCS2 from APC 36. A transmission RF signal amplified by RFPGA 35_1 is output from output terminal Tx1 and input to corresponding HPA 40_1 through matching circuit 16_1. A transmission RF signal amplified by RFPGA 35_2 is output from output terminal Tx2 and input to corresponding HPA 40_2 through matching circuit 16_2. Each matching circuit causes output impedance of the RFPGA and input impedance of the HPA to match with each other.

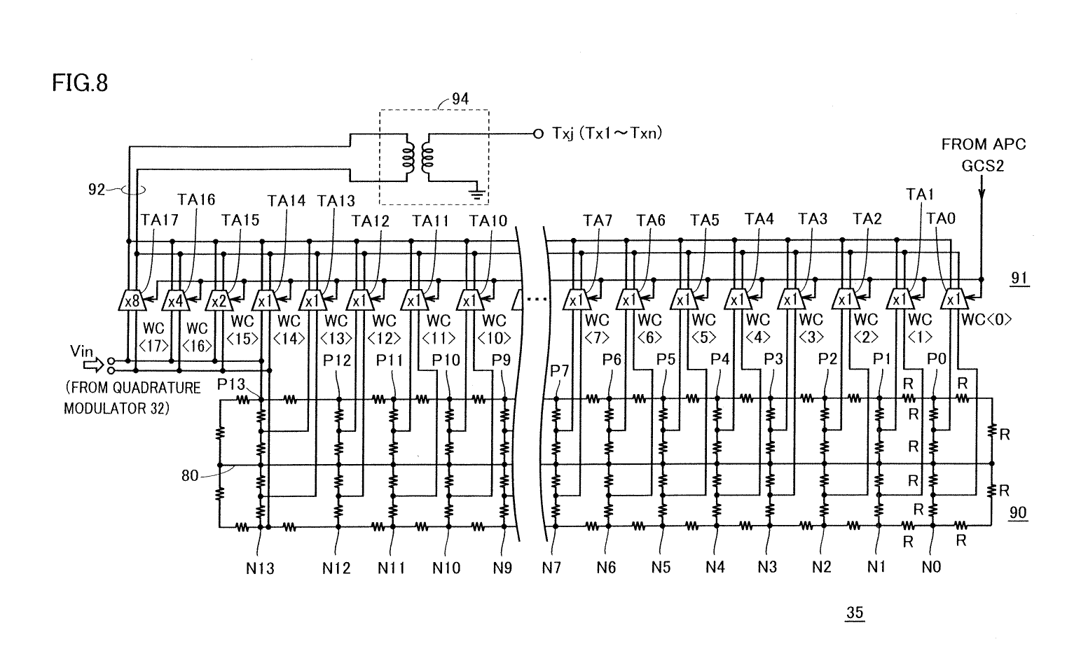

FIG. 8 is a diagram showing one example of a configuration of RFPGA 35. Referring to FIG. 8, RFPGA 35 includes a resistor ladder 90, a current/voltage conversion portion 91, and a high-frequency transformer circuit 94.

Resistor ladder 90 divides an input voltage Vin input from quadrature modulator 32. Resistor ladder 90 includes a plurality of resistor elements coupled like a network. As shown in FIG. 8, each one resistor element is provided between adjacent nodes of nodes P0 to P13 and between adjacent nodes of nodes N0 to N13. Two resistor elements connected in series are provided between each of nodes P1 to P12, N1 to N12 and a virtual AC ground line 80. Two resistor elements connected in series are provided between each of nodes P0, P13, N0, N13 and virtual AC ground line 80, and two resistor elements connected in series are further provided in parallel to the string of these two resistor elements. Each resistor element has a resistance value R. Input voltage Vin is applied across nodes P13 and N13.

According to the configuration of resistor ladder 90 above, a voltage across nodes Pi, Ni (i being an integer not smaller than 0 and not greater than 12) is ½ of a voltage across adjacent nodes Pi+1, Ni+1. Therefore, a voltage across nodes Pi, Ni (i being an integer not smaller than 0 and not greater than 12) is equal to a value obtained by dividing input voltage Vin by 2 to the (13−i)th power.

Current/voltage conversion portion 91 includes 18 transconductance amplifiers TA0 to TA 17 (denoted as transconductance amplifier TA when they are collectively referred to or when an unspecified one is indicated). Transconductance amplifier TA0 receives input of a voltage obtained by dividing a voltage across nodes P0, N0 into ½ by a resistor element. Similarly, transconductance amplifier TAi (i being an integer not smaller than 0 and not greater than 13) receives input of a voltage obtained by dividing a voltage across nodes Pi, Ni into ½. Therefore, a voltage input to transconductance amplifier TAi (i being an integer not smaller than 0 and not greater than 13) is equal to a value obtained by dividing input voltage Vin by 2 to the (14−i)th power. Input voltage Vin is input to transconductance amplifiers TA14 to TA17.

Each of transconductance amplifiers TA0 to TA17 converts an input voltage to a current and supplies the current to an output signal line 92. Here, transconductance amplifiers TA0 to TA14 have transconductance gm equal to one another. Transconductances of transconductance amplifiers TA15 to TA17 are 2 gm, 4 gm, and 8 gm, respectively.

Operations of transconductance amplifiers TA0 to TA17 are controlled by control words WC<0> to WC<17>, respectively. Control words WC<0> to WC<17> correspond to each bit of gain adjustment signal GCS2 which is a multi-bit parallel signal. Each transconductance amplifier TA outputs a current in accordance with an input voltage to output signal line 92 when a corresponding control word is “1”, and does not output a current to output signal line 92 when a corresponding control word is “0”.

Output signals from transconductance amplifiers TA0 to TA17 are transmitted to an output terminal Txj in FIG. 1 (j being an integer not smaller than 1 and not greater than n) through high-frequency transformer circuit 94. High-frequency transformer circuit 94 separates a DC component of an output signal from each of transconductance amplifiers TA0 to TA17 and carries out impedance conversion.

With RFPGA 35 having the configuration above, gain adjustment in a range from −66 dB to 12 dB in steps of 0.125 dB can be made. It is assumed that, in the case where only transconductance amplifier TA16 operates (that is, only control word WC<16> is “1”). transconductance gm is set such that the gain of RFPGA 35 is 0 dB. The maximum gain of 12 dB is realized when each of higher-order 8 bits of the control words, that is, WC<17> to WC<10>, is “1” and other bits are “0”. The minimum gain of −66 dB is realized when only WC<5> is “1” and other bits are “0”.

(DC Offset Cancellation Circuit)

Referring again to FIG. 6, transmission portion 22 further includes DC offset cancellation circuit 37. DC offset cancellation circuit 37 is provided in order to prevent leakage of a carrier signal (referred to as carrier leakage) caused in quadrature modulator 32_1, 32_2, that is, in order to cancel difference (offset) in DC level between differential signals of the baseband signals input to quadrature modulator 32, which is the cause of carrier leakage. Specifically, DC offset cancellation circuit 37 uses outputs from quadrature modulators 32_1, 32_2 and local carrier signals LOI, LOQ from frequency dividers 31_1, 31_2 to thereby operate an amount of correction. DC offset cancellation circuit 37 calculates such an amount of correction as decreasing offset of the DC level between differential signals and supplies the calculated amount of correction to adder 38_1, 38_2. Adders 38_1, 38_2 add a result of operation by DC offset cancellation circuit 37 to the digital baseband signals output from two DPGAs 24_1, 24_2 respectively and output the corrected digital baseband signals. A specific configuration of DC offset cancellation circuit 37 is described, for example, in Japanese Patent Application No. 2009-281360.

(HPA Module)

FIG. 6 shows a configuration of HPA module 11 connected to output terminal Tx1, Tx2 among output terminals Tx1 to Txn shown in FIG. 1, through matching circuit 16_1, 16_2. HPA 40_1, 40_2 is a variable gain high power amplifier (HPA) for amplifying an RF signal output from output terminal Tx1, Tx2. When quadrature modulator 32 and RFPGA 35 corresponding to a frequency band used by the RFIC operate, the HPA corresponding to that frequency band performs an amplification operation and other HPAs do not operate. A transmission RF signal amplified by HPA 40_1, 40_2 is sent to front end module 12. HPA module 11 further includes a coupler 41 and a detector (DET) 42 provided in correspondence with HPA 40, a switch (SW) 43, and a DC-DC converter 44. FIG. 6 shows couplers 41_1, 41_2 corresponding to HPAs 40_1, 40_2 respectively and detectors 42_1, 42_2 corresponding to couplers 41_1, 41_2 respectively.

Coupler 41 detects an RF signal output from corresponding HPA 40. Detector 42 detects an output waveform of corresponding coupler 41. Consequently, detector 42 senses output electric power from corresponding HPA 40. For example, a diode detector is employed as detector 42. Switch 43 selects output from detector 42 corresponding to HPA 40 performing an amplification operation among a plurality of detectors 42 and provides the selected output as a control signal CS2 to transmission portion 22 as feedback.

DC-DC converter 44 converts a voltage level of a gain adjustment signal GCS3 output from APC 36 for supply to each HPA 40. The gain of HPA 40 is adjusted by gain adjustment signal GCS3.

[Detailed Configuration and Operation of APC]

(Outlines of Operation of APC)

In the case of a communication scheme where a plurality of mobile stations (portable telephones) use carrier waves of the same frequency as in the CDMA scheme, transmission electric power from each mobile station should be adjusted in order to equalize reception electric power at the base station. For example, the base station gives instructions to a mobile station to increase transmission electric power when the mobile station is far from the base station and decrease transmission electric power when the mobile station is close to the base station. Namely, the base station transmits to the mobile station, any instruction “to increase transmission power,” “to decrease transmission power,” and “not to increase or decrease transmission power.” This instruction is hereinafter referred to as “transmission power information.” An amount of transmission power by which the mobile station increases or decreases in response to one instruction (transmission power information) is predetermined, such as increase or decrease in steps of 0.5 dB, increase or decrease in steps of 1 dB, and increase or decrease in steps of 2 dB. The transmission power information is transmitted from the base station to each mobile station (portable telephone) every 500 μs in the LTE mode and every 667 μs in the R99 mode and the HSUPA mode.

In addition to a data channel for transmission and reception of call conversation data and other various types of data, there is a control channel between the base station and the mobile station. Various types of control information including the transmission power information transmitted from the base station are received by the mobile station through the control channel. The received various types of control information are down-converted by RFIC 10 and thereafter decoded (demodulated) by baseband IC 5. The transmission power information obtained as a result of demodulation is sent from baseband IC 5 to APC 36 in transmission portion 22 through digital RF interface 20. Therefore, the transmission power information received from baseband IC 5 by APC 36 is a digital signal for identifying “power increase”, “no necessity for increase and decrease,” and “power decrease”. For example, in the case where power increase and decrease by 1 dB is caused by one instruction by way of example, the transmission power information received by the APC is expressed as a digital value indicating “power increase”=+1, “no necessity for increase and decrease”=0, and “power decrease”=−1.

APC 36 provided in transmission portion 22 of RFIC 10 receives a control signal CS1 including the transmission power information. Control signal CS1 includes temperature information, frequency information, transmission mode information, and the like, in addition to the transmission power information. APC 36 further receives control signal CS2 output from detector 42. APC 36 adjusts the gain of DPGA 24, RFPGA 35, and HPA 40 every defined time set in each transmission mode, based on these control signals CS1, CS2. Control based on control signal CS1, CS2 will specifically be described below.

(Control Based on Transmission Power Information)

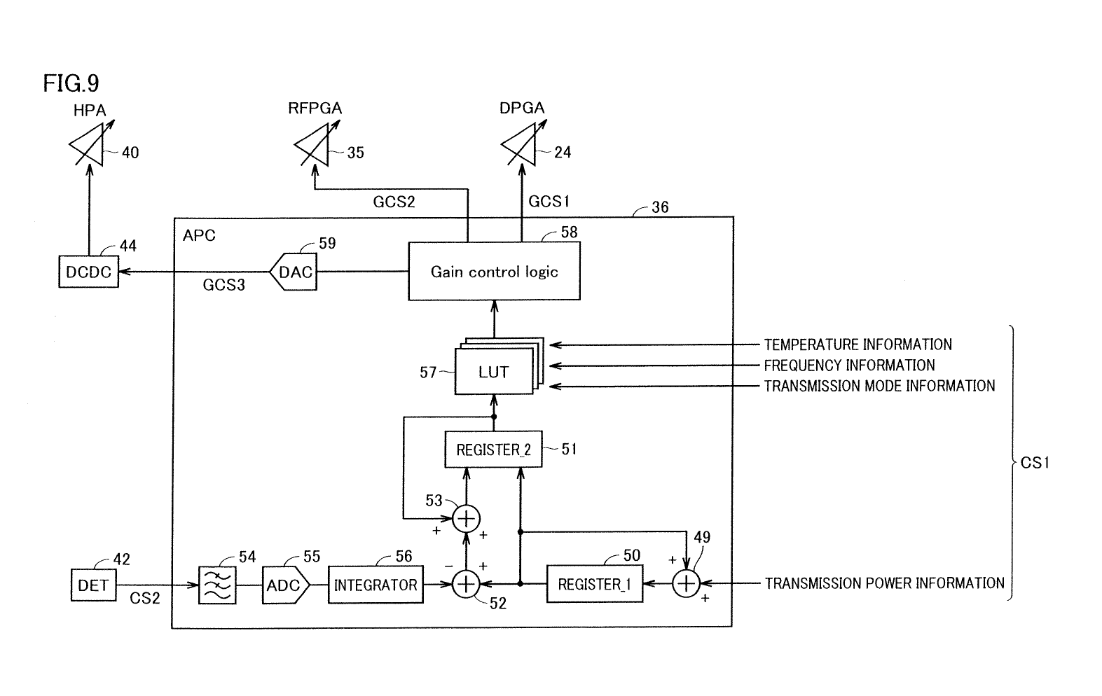

FIG. 9 is a block diagram showing a configuration of APC 36. Referring to FIG. 9, APC 36 includes first and second registers 50, 51, an adder 49, a gain setting portion 57, a gain control logic 58, and a digital-to-analog converter (DAC) 59.

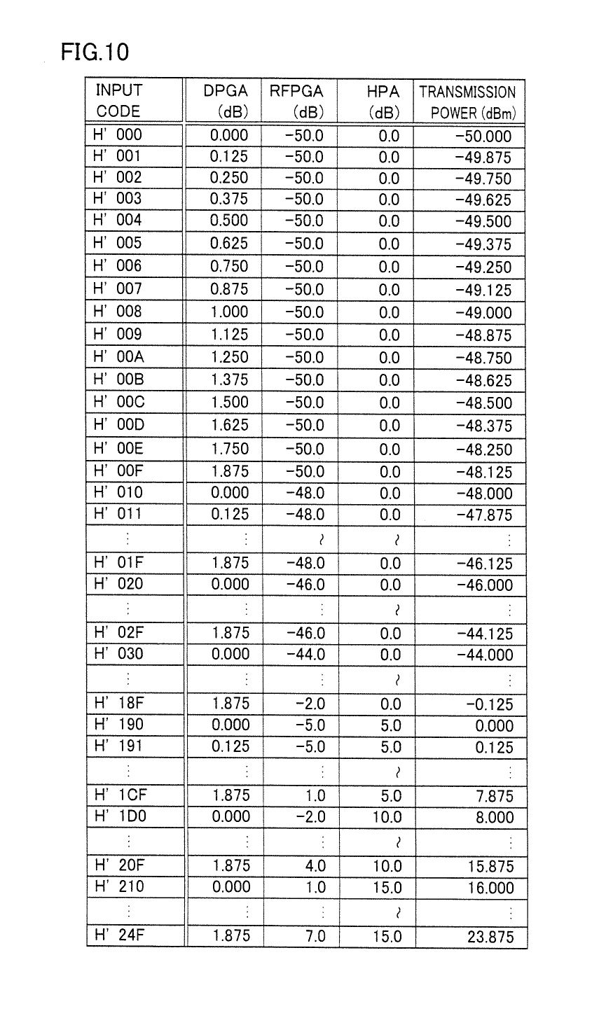

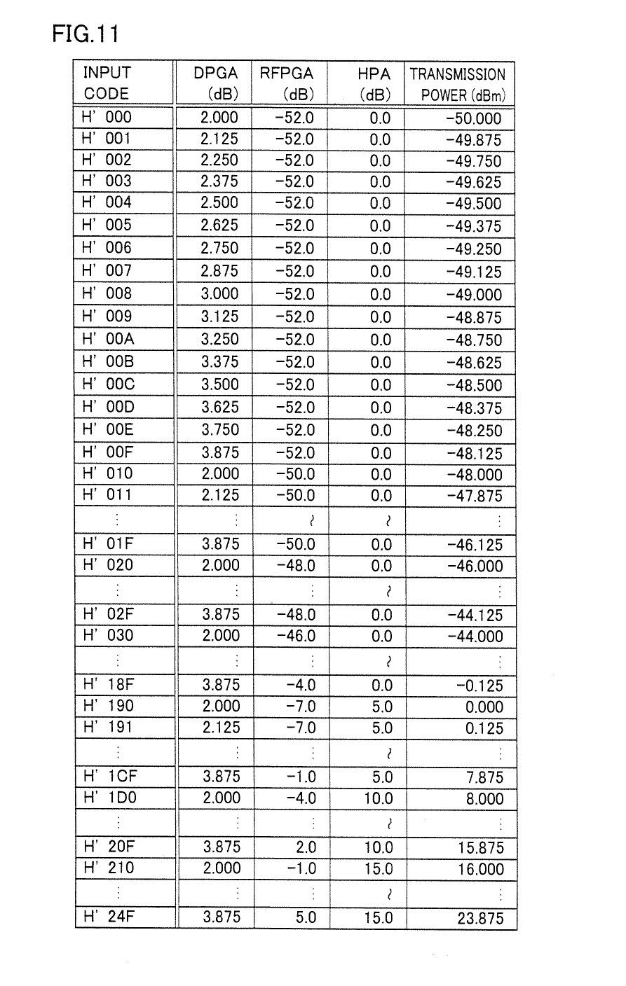

First register 50 holds a currently set value of antenna transmission power. Specifically, a set value for transmission power is held in a format of an input code shown in FIGS. 10, 11, and the like. Adder 49 receives the transmission power information from baseband IC 5 and adds thereto the set value held in first register 50, to thereby generate a value for transmission power to newly be set. A value in first register 50 is updated by the set value for transmission power output from adder 49 every prescribed time (every 500 μs in the LTE mode and every 667 μs in the HSUPA mode and the R99 mode).

Second register 51 holds a set value for transmission power of the antenna transferred from first register 50. When contents in first register 50 are updated, the updated set value for transmission power is transferred as it is to second register 51. Unlike the configuration in FIG. 9, the configuration may be such that the value held in first register 50 is transferred to second register 51 through adders 52, 53 which will be described later. In this case, at the time of transfer, the other inputs of adders 52, 53 are set to 0.

Gain setting portion 57 contains, for example, an SRAM (Static Random Access Memory). The SRAM stores in a look up table (LUT), control data for DPGA 24, RFPGA 35, and HPA 40 to be set in correspondence with a value for transmission power of the antenna. When power of RFIC 10 is turned on, a CPU (not shown) in RFIC 10 writes control data in the SRAM and constructs the look up table. Instead of the SRAM, a non-volatile memory may be employed. A non-volatile memory would obviate the need for write processing at the time of turn-on of power.

A look up table is constituted of a plurality of tables. Gain setting portion 57 specifies one table based on temperature information, frequency information, and transmission mode information included in control signal CS1. Then, gain setting portion 57 receives a set value for transmission power of the antenna held in second register 51 as an address signal and outputs control data designated by the set value for transmission power of the antenna among a plurality of pieces of control data held in one specified table.

A control code output from gain setting portion 57 is converted to a control signal code for adjusting gain of DPGA 24, RFPGA 35, and HPA 40 by gain control logic 58 and output as gain adjustment signals GCS1, GCS2, GCS3 to DPGA 24, RFPGA 35, and HPA 40, respectively. It is noted that gain adjustment signal GCS3 is converted to an analog signal by DAC 59 and thereafter a voltage level thereof is converted by DC-DC converter 44 for output to HPA 40.

FIG. 10 is a diagram schematically showing an example of one certain table stored in gain setting portion 57.

In general, the gain [dB] of DPGA 24, RFPGA 35, and HPA 40 relates to transmission power [dBm] of the antenna. Actually, though attenuation of electric power through a path from DPGA 24 to RFPGA 35 and a path from HPA 40 to the antenna is also relevant, for the sake of brevity, in the description below, the attenuation of electric power through these paths is ignored. In this case, with voltage amplitude (an effective value) of a digital transmission baseband signal being denoted as Vbb [dBV], total gain of DPGA 24, RFPGA 35, and [IPA 40 being denoted as Gamp [dB], and input impedance of the antenna being set to 50Ω, transmission power Pt [dBm] of the antenna is expressed as follows.

Pt=Gamp+Vbb+13.01 (1)

The tables shown in FIGS. 10 to 13 show Vbb=−13.01 [dBV], for the sake of brevity. A value for Vbb is actually different depending on design of baseband IC 5.

As shown in FIG. 10, transmission power of the antenna (output electric power from HPA 40) can be set at 592 points in total in steps of 0.125 dB, within a range from −50 dB to 23.875 dB. The input code in the table has values at 592 points from H′000 to H′24F (“H”' representing hexadecimal notation), in correspondence with a set value for transmission power of the antenna. A control code is set in correspondence with each input code. The control code is information specifying a value for the gain (dB) to be set for each of DPGA 24, RFPGA 35, and HPA 40. When gain setting portion 57 receives a set value for transmission power from second register 51, gain setting portion 57 outputs a control code corresponding to the set value for transmission power. For example, in the case where the transmission power is −50 dBm (input code: H′000), the gains of DPGA 24, RFPGA 35, and HPA 40 are set to 0 db, −50 dB, and 0 dB, respectively.

The gain of HPA 40 is adjusted to increase particularly when high transmission power is required in the antenna. When the output is low, the gain is fixed to 0 dB, and the gain is adjusted from a level lower by 20 to 30 dBm than the upper limit (23.875 dBm) of the set transmission power. Specifically, while the input code is from H′000 to H′18F (400 steps), the gain is fixed to 0 dB, and while the input code is from H′190 to H′1CF (64 steps), the gain is set to 5 dB. While the input code is from H′1D0 to H′20F (64 steps), the gain is set to 10 dB. While the input code is from H′210 to H′24F (64 steps), the gain is set to 15 dB.

The gain of RFPGA 35 is set to −50 dB when the input code is set to H′000. While the input code is from H′000 to H′18F, the gain increases by 2 dB every 16 steps of input code values, and when the input code value is set to H′18F, the gain is set to −2.0 dB. When the input code is H′190, the gain decreases by 3 dB and it is set to −5.0 dB. While the input code is from H′190 to H′1CF, the gain increases by 2 dB every 16 steps of the input code values, and when the input code is set to H′1CF, the gain is set to 1.0 dB. When the input code is H′1D0, the gain decreases by 3 dB and it is set to −2.0 dB. While the input code is from H′1D0 to H′24F, the gain increases by 2 dB every 16 steps of the input code values, and when the input code is set to H′24F, the gain is set to 7.0 dB. Namely, while the input code is from H′000 to H′24F, a total value of gains of RFPGA 35 and HPA 40 (gain of an output voltage of HPA 40 from a point of view of an input voltage of RFPGA 35) increases by 2 dB every 16 steps of the input code values within a range from −50 dB (H′000) to 22 dB (H′24F).

The gain of DPGA 24 varies within a range from 0 dB to 1.875 dB. The gain of DPGA 24 increases by 0.125 dB each time an input code increases by 1 step. After the gain attains to 1.875 dB, the gain returns next to 0 dB and the gain again increases by 0.125 dB. Therefore, the gain of DPGA 24 repeats from 0 dB to 1.875 dB every 16 steps of the input code values.

Thus, the gain of DPGA 24 is adjusted in steps of 0.125 dB, the gain of RFPGA 35 is adjusted in steps greater than that for DPGA 24 (2.000 dB), and the gain of HPA 40 is adjusted in steps further greater than that for RFPGA 35 (5.000 dB). Namely, a higher value of the transmission power of the antenna (a portion not lower than 2 dB) is adjusted by the gain of HPA 40 and RFPGA 35, and a value lower than that (a portion from 0.000 dB to 1.875 dB) is adjusted by the gain of DPGA 24.

RFPGA 35 and HPA 40 are implemented by analog circuits. It is difficult to accurately adjust the gain, for example in such small steps as less than 0.5 dB, and in order to accurately adjust the gain, a complicated circuit configuration is required and hence a circuit size becomes large. In contrast, since the amplification by DPGA 24 is realized by digital operation, the gain can accurately be adjusted by little influence by noise even in small steps. Since a considerable current is required for an amplification operation in a range in which such high transmission power as exceeding 0 dBm is required, the gain is desirably adjusted not by RFPGA 35 alone but in cooperation with HPA 40 which is a chip different from RFIC 10.

(Control Based on Control Signal CS2)

Regarding the transmission power of the antenna, in many cases, there is an error between a design value (a value held in first register 50 in FIG. 9) and a value at the time of actual transmission. This is because it is difficult to set the gain as designed in RFPGA 35 and HPA 40 which are analog circuits. In order to adjust such an error, as shown in FIG. 9, APC 36 has such a mechanism as receiving feedback of a signal (control signal CS2) obtained by the detection of output from operating HPA 40 by detector 42 and adjusting the gain.

Referring to FIG. 9, APC 36 further includes a low pass filter 54, an AD converter (ADC) 55, an integrator 56, and adders 52, 53.

Input control signal CS2 is converted to a digital signal by AD converter 55 after a high frequency exceeding a cut-off frequency is removed by low pass filter 54. An output signal from AD converter 55 represents the transmission power of HPA 40. Integrator 56 calculates average electric power within a certain time period based on a plurality of digital values sampled by AD converter 55.

Adder 52 calculates a difference between a set value for the transmission power of the antenna held by first register 50 and the actual transmission power output by integrator 56. This difference represents an error between output electric power as designed and actual output electric power. Adder 53 adds the error output from adder 52 to the set value for the transmission power of the antenna held in second register 51, and rewrites second register 51 with a result of addition. Each gain of DPGA 24, RFPGA 35, and HPA 40 is again adjusted with the new rewritten set value for transmission power of the antenna. The error is adjusted as this feedback control is repeated within a prescribed time period (within 500 μs in the LTE mode and within 667 μs in the R99 mode and the HSUPA mode). Finally, the actual output electric power of HPA 40 is adjusted to a value of transmission power to be set, which is held in first register 50. During feedback control, first register 50 holds a value as it is.

This feedback control may be carried out during a period of high output in which power consumption is particularly high, such as during a period of high transmission power higher than a level lower by 20 to 30 dB than the upper limit of the adjusted transmission power (the level of 0 dBm).

(Control Based on Transmission Mode Information)

Referring to FIG. 9, in gain setting portion 57 in APC 36, tables different in accordance with transmission modes are prepared. Specifically, tables in which a value for gain of DPGA 24 is varied in accordance with a transmission mode are prepared. Gain setting portion 57 receives transmission mode information specifying a transmission mode from the baseband IC and selects a table corresponding to the transmission mode information. Description will be given below with reference to specific examples.

FIG. 11 is a diagram schematically showing an exemplary table corresponding to a transmission mode different from that in FIG. 10, which is stored in gain setting portion 57. FIG. 10 shows an exemplary table in the case of transmission in the LTE mode and the HSUPA mode, and FIG. 11 shows an exemplary table in the case of transmission in the R99 mode. In the table in FIG. 11, the gain of DPGA 24 for each input code is higher by 2 dB and the gain of the RFPGA is lower by 2 dB, than that in the table in FIG. 10. Namely, in the case of the table in FIG. 11, gain of DPGA 24 varies in a range from 2 dB to 3.875 dB with 0.125 dB being defined as 1 step. Since a value for gain of HPA 40 in FIG. 11 is the same as in the case of FIG. 10, a value for transmission power for an input code remains unchanged between FIGS. 10 and 11.

Examples in FIGS. 10 and 11 are generalized as follows. A range [dB] of gain set in the case of the LTE mode and the HSUPA mode is denoted as G1min to G1max (G1min representing the lower limit of the range and G1max representing the upper limit of the range) and magnitude of that step is denoted as Δ1 [dB]. A range [dB] of gain set in the case of the R99 mode lower in PAPR than in the case of the LTE mode and the HSUPA mode is denoted as G2min to G2max (G2min being defined as the lower limit of the range and G2max being defined as the upper limit of the range) and magnitude of that step is denoted as Δ2 [dB]. In this case, the gain is set such that relation below is satisfied.

G1max<G2max, G1min<G2min (2)

In addition, it is desirable that the following relations are satisfied.

G1max≦G2min (3)

G1max−G1min=G2max−G2min (4)

Δ1=Δ2 (5)

In the case of the examples in FIGS. 10 and 11, setting as G1min=0 dB, G1max=1.875 dB, G2min=2 dB, G2max=3.875 dB, and A1=A2=0.125 dB is made.

According to the setting above, as a PAPR of digital transmission baseband signal I_d1. Q_d1 is lower, the gain of DPGA 24 is greater. Consequently, control is carried out such that peak amplitude of the analog transmission baseband signal output from DAC 25 is as constant as possible. In addition, increment and decrement of the gain of DPGA 24 is adjusted by the gain of RFPGA 35, and transmission electric power from the antenna is controlled to be constant. Specifically, control is carried out such that, as a PAPR of a signal to be transmitted is lower, the gain of DPGA 24 is increased and the gain of RFPGA 35 is decreased. Consequently, even in the case where a high PAPR signal is transmitted in a mode where high-speed communication can be carried out, the signal can be transmitted without distortion. In the case of transmission of a low PAPR signal, since the gain of the RFPGA greater in current consumption than the DPGA can be decreased, current consumption can be suppressed and a battery of a portable terminal can be saved. Here, since linearity of analog baseband circuit 27 such as DAC 25 or low pass filter 26 is mainly determined by a power supply voltage or a circuit configuration, increase in signal amplitude does not give rise to a problem.

Since magnitude of a PAPR value generally depends on a modulation scheme, a multiplexing scheme, and a multiple access scheme, it can be said in principle that the advantage above can be realized by adjusting the gain of the DPGA and the RFPGA in accordance with at least any one of the modulation scheme, the multiplexing scheme, and the multiple access scheme. For example, the configuration may be such that baseband IC 5 performing processing for modulation and multiplexing generates information indicating at least any of the modulation scheme, the multiplexing scheme, and the multiple access scheme and the RFIC receives that information to adjust the gain of the DPGA and the RFPGA. On the other hand, such a configuration is more simple that a PAPR value is different among a plurality of transmission modes different in at least one of the modulation scheme, the multiplexing scheme, and the multiple access scheme as in the LTE, the HSUPA, and the R99, and baseband IC 5 generates information representing any of the plurality of transmission modes and the RFIC receives that information to adjust gain of the DPGA and the RFPGA as in the present embodiment.

In addition, according to RFIC 10 in the first embodiment, since a dynamic range of DAC 25 can be made maximum use of as DPGA 24 adjusts the amplitude of digital transmission baseband signal I_d1, Q_d1, noise characteristics of output from DAC 25 (that is, CNR: Carrier-to-Noise Ratio) can be improved. Furthermore, with increase in amplitude of an output signal from DAC 25, noise characteristics from DAC 25 to RFPGA 35 can be improved.

Additionally, the configuration is such that power control is finely adjusted by DPGA 24 (that is, lower orders of a power value to be set are adjusted). Since DPGA 24 performs digital processing, it is capable of carrying out accurate power control less in variation. For example, since the RFPGA performs analog processing, variation is great, and if an attempt to suppress such variation is made, an area of the RFPGA increases.

Furthermore, according to RFIC 10 in the first embodiment, power control of antenna output is realized by adjustment of the gain of DPGA 24 and the RFPGA. For example, as compared with the RFIC described in Japanese Patent Laying-Open No. 2007-5996 (PTL 3), carrier leakage can be decreased. As described in this document, in the case where the RFPGA is constituted of amplifiers in a plurality of stages, change in gain of an amplifier in a preceding stage will change an operation point and hence DC offset which is the cause of carrier leakage varies. Since the gain of DPGA 24 is adjusted in RFIC 10 in the first embodiment, carrier leakage does not increase.

It is noted that, in the present embodiment, the gain of DPGA 24 in the LTE E mode and the HSUPA mode is controlled to vary within the same range (from 0 dB to 1.875 dB). Alternatively, change in the gain of DPGA 24 may be different between the LTE mode and the HSUPA mode. In consideration of the fact that the HSUPA mode is lower in PAPR than the LIE mode and greater therein than the R99 mode, a minimum value and a maximum value of the gain of DPGA 24 in the HSUPA mode may be made greater than those in the LTE mode and made smaller than those in the R99 mode. For example, the range of the gain of DPGA 24 in the HSUPA mode may be from 1 dB to 2.875 dB. In that case, a gain set value of RFPGA 35 for an input code should be re-adjusted to a value different from that in FIG. 10.

On the other hand, in the present embodiment, the gain of DPGA 24 has been controlled to vary within a certain range. In contrast, for example, the gain of DPGA 24 may be fixed to a value in accordance with a transmission mode such that the gain of DPGA 24 is set to 0 dB in the case of the LTE mode and the HSUPA mode and the gain of DPGA 24 is set to 2 dB in the case of the R99 mode. In this case, though the gain of RFPGA 35 should be adjusted in steps of 0.125 dB, the gain can be adjusted in steps of 0.125 dB by using RFPGA 35 having the configuration described with reference to FIG. 8. It is noted that adjustment by DPGA 24 in fine steps enables more accurate gain adjustment also with little influence by noise.

(Control Based on Temperature Information and Frequency Information)

RFIC 10 in the first embodiment has a mechanism for setting optimal gain of RFPGA 35 and HPA 40 in accordance with an environment where a portable telephone is used. A frequency and a temperature represent typical parameters of an environment of use. In RFPGA 35 and HPA 40 which are analog circuits, gain characteristics of an output voltage with respect to an input voltage vary in accordance with a frequency and a temperature during use. For example, since the gain of the HPA lowers with increase in temperature, lowering in the gain of the HPA should be compensated for by increase in a set value for the gain of the RFPGA and the DPGA. In particular, rough correction of gain variation in the HPA is adjusted by increase and decrease in the gain of the RFPGA, and fine correction is adjusted by increase and decrease in gain of the DPGA. Namely, rather than uniquely setting the gain of RFPGA 35 and HPA 40 for a set value for transmission power, distribution of the gain is desirably changed between RFPGA 35 and HPA 40 in accordance with a frequency and a temperature.

Frequency information is information specifying a frequency of a carrier used by a portable telephone during actual transmission, that is, a frequency of a local oscillation signal made use of by quadrature modulator 32 for modulation. This frequency information is a signal generated within the RFIC based on information from baseband IC 5, and it is made use of also as control information for setting a frequency of local oscillation signals LOI, LOQ input to quadrature modulator 32.

Temperature information is information specifying a temperature of RFIC 10 during use. Specifically, it is information specifying in which sub range the temperature of the RFIC is, with a temperature range in which operation of the RFIC is ensured (for example, from −40° C. to 90° C.) being divided into a plurality of sub ranges (for example, 6 sub ranges in steps of 25° C.). A temperature measurement circuit (not shown) constituted of a transistor is provided in RFIC 10 and temperature information is generated in RFIC 10 based on a result of measurement.

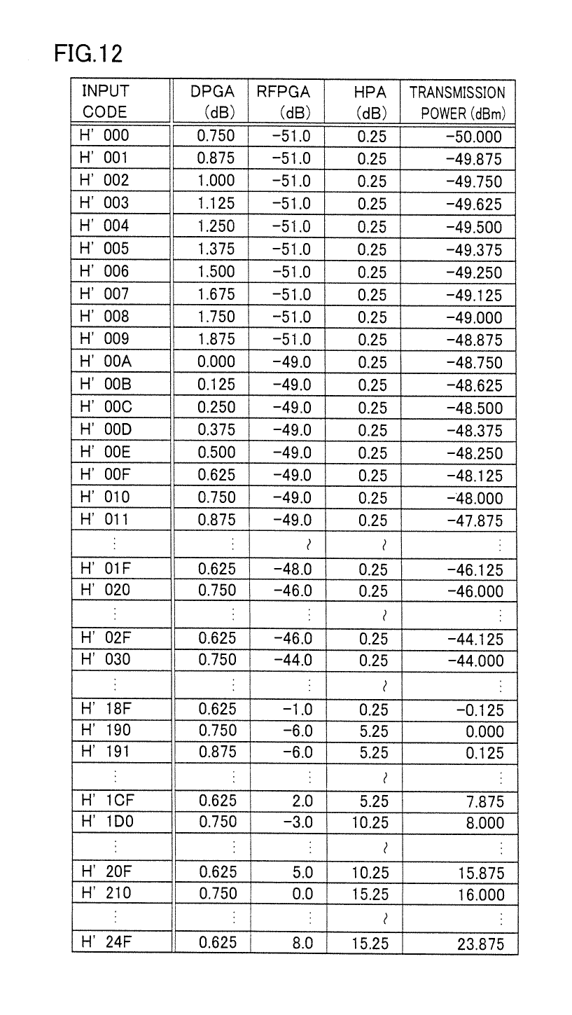

Gain setting portion 57 in FIG. 9 has a plurality of tables in accordance with the frequency information and the temperature information in the LTE mode and the HSUPA mode and has a plurality of tables similarly in accordance with the frequency information and the temperature information in the R99 mode. FIG. 12 shows an exemplary table corresponding to the temperature information and the frequency information different from that in FIG. 10, in the LTE mode or the HSUPA mode. When the gain of the HPA has a value greater by 0.25 dB than the gain of the HPA in FIG. 10, a value of the gain of the DPGA corresponding to an input code is different from that in FIG. 10, although a range of the gain of the DPGA (from 0 dB to 1.875 dB) is the same as in FIG. 10. The gain of the DPGA is set such that 0.750 dB, 0.875 dB, 1.000 dB, . . . , 1.875 dB, 0.000 dB, 0.125 dB, . . . , 0.500 dB, and 0.625 dB are repeated every 16 steps from input code H′000. The gain of the RFPGA is −51.0 dB when the input code is set to H′000, and thereafter the gain increases by 2 dB when the input code is set to H′**A (** being any value). In addition, when transition from H′18F to H′190 is made, transition from H′1CF to H′1D0 is made, and transition from H′20F to H′210 is made, the gain increases by 5 dB in each case. Such tables are prepared as many as conditions specified by the frequency information and the temperature information (for example, from 1000 to 2000).

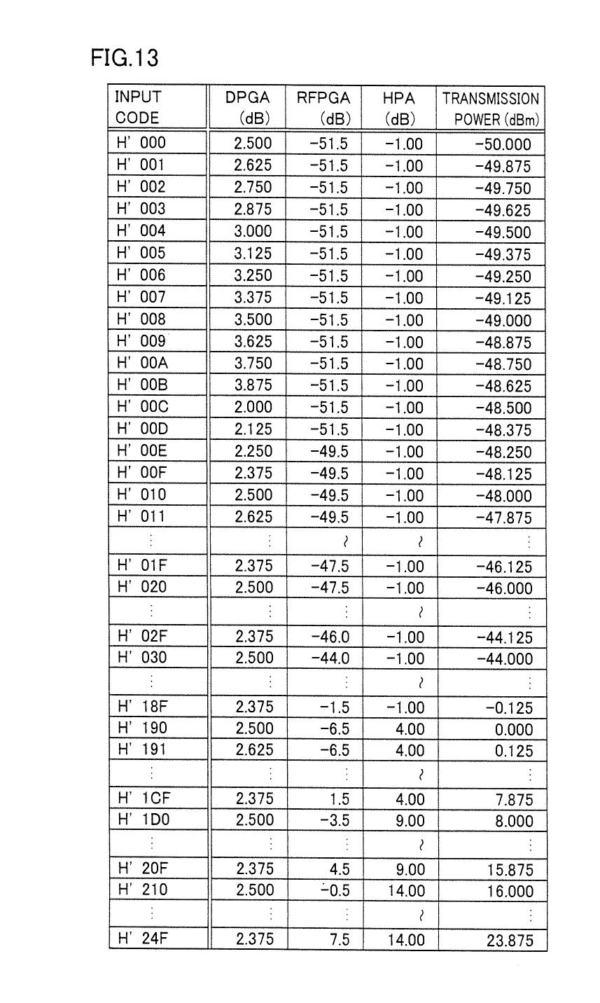

FIG. 13 shows an exemplary table corresponding to the temperature information and the frequency information different from that in FIG. 11, in the R99 mode. In the table in FIG. 13, when the gain of the HPA has attained to a value smaller by 1 dB than the gain of the HPA in FIG. 11, a value of the gain of the DPGA corresponding to an input code is different from that in FIG. 11, although a range of the gain of the DPGA (from 2 dB to 3.875 dB) is the same as in FIG. 11. The gain of the DPGA is set such that 2.500 dB, 2.625 dB, 2.750 dB, . . . , 3.875 dB, 2.000 dB, 2.125 dB, 2.250 dB, and 2.375 dB are repeated every 16 steps from the input code of H′000. The gain of the RFPGA is −51.5 dB when the input code is set to H′000, and thereafter the gain increases by 2 dB when the input code is set to H′**E (** being any value). In addition, when transition from H′18F to H′190 is made, transition from H′1CF to H′1D0 is made, and transition from H′20F to H′210 is made, the gain increases by 5 dB in each case. Such tables are prepared as many as conditions specified by the frequency information and the temperature information (for example, from 1000 to 2000).

Naturally, a table may be set as appropriate based on information relating to a parameter if there is any parameter affecting the gain of the RFPGA and the HPA, other than the frequency information and the temperature information. As a simple configuration, a configuration may be such that only two tables (such as tables in FIGS. 10 and 11) in accordance with transmission mode information are prepared.

### Second Embodiment

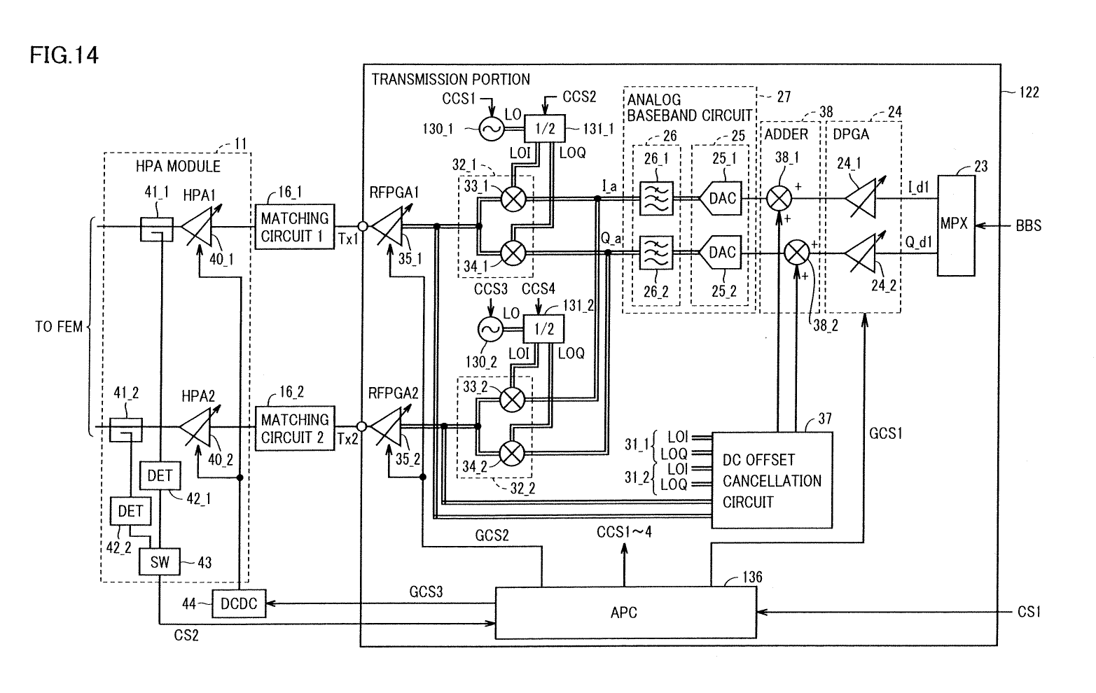

FIG. 14 is a block diagram showing a configuration of a transmission portion 122 according to a second embodiment of this invention. Local oscillators 130_1, 130_2 in FIG. 14 are different from local oscillators 30_1, 30_2 in FIG. 6 in that the former is capable of adjusting magnitude of a drive current that flows during operation in response to current adjustment signals CCS1, CCS3, respectively, and ½ frequency dividers 131_1, 131_2 in FIG. 14 are different from ½ frequency dividers 31_1, 31_2 in FIG. 6 in that the former is capable of adjusting magnitude of a drive current that flows during operation in response to current adjustment signals CCS2. CCS4, respectively. In addition to a function of APC 36 in FIG. 6, an APC 136 in FIG. 14 generates current adjustment signals CCS1 to CCS4 in accordance with transmission mode information and outputs those signals. Since FIG. 14 is otherwise the same as FIG. 6, the same or corresponding elements have the same reference characters allotted and description will not be repeated.

Noise characteristics are improved by increasing the gain of DPGA 24 in the R99 mode, as compared with the LTE mode and the HSUPA mode. Therefore, there may be a room in noise characteristic margin in the R99 mode. In that case, an amount of a drive current which flows during operation of local oscillator 130 and ½ frequency divider 131 can be decreased to such an extent as ensuring margin for noise characteristics, and hence power consumption can be reduced. Current adjustment signals CCS1 to CCS4 are not limited to a 1-bit signal, and they may be a multi-bit signal. A drive current can be adjusted in multiple steps in accordance with multi-bit current adjustment signals CCS1 to CCS4.

It should be understood that the embodiments disclosed herein are illustrative and non-restrictive in every respect. The scope of this invention is defined by the terms of the claims, rather than the description above, and is intended to include any modifications within the scope and meaning equivalent to the terms of the claims.

### REFERENCE SIGNS LIST

5 baseband IC; 10 RFIC; 11 HPA module; 12 front end module; 13 antenna; 20 digital RF interface; 21 reception portion; 22, 122 transmission portion; 24 DPGA; 25 DAC; 30, 130 local oscillator; 31, 131 ½ frequency divider; 32 quadrature modulator; 35 RFPGA; 36, 136 APC (automatic power controller); and 40 HPA.

1. A semiconductor device capable of transmitting data in accordance with each of a plurality of transmission modes, comprising:
a first amplification portion receiving a first digital baseband signal and generating a second digital baseband signal by amplifying said first digital baseband signal with a first gain, the first gain being variable;
a digital-to-analog conversion portion for converting said second digital baseband signal generated by said first amplification portion into an analog baseband signal;
a modulation portion for generating a transmission signal by modulating a local oscillation signal with said analog baseband signal;
a second amplification portion for amplifying said transmission signal with a variable second gain; and
a control unit receiving information representing any of said plurality of transmission modes and adjusting said first gain in accordance with said information.

2. The semiconductor device according to claim 1, wherein
said control unit further adjusts said second gain in accordance with said information.

3. The semiconductor device according to claim 2, wherein
said control unit adjusts said first and second gains such that a minimum amount of change in said first gain is less than a minimum amount of change in said second gain.

4. The semiconductor device according to claim 1, wherein
as compared with a peak to average power ratio of said first digital baseband signal in a first transmission mode of said plurality of transmission modes, a peak to average power ratio of said first digital baseband signal in a second transmission mode of said plurality of transmission modes is higher, and
when said first amplification portion receives said first digital baseband signal in said first transmission mode and said first digital baseband signal in said second transmission mode, said control unit makes said first gain in said first transmission mode greater than said first gain in said second transmission mode.

5. The semiconductor device according to claim 1, wherein
as compared with a peak to average power ratio of said first digital baseband signal in a first transmission mode of said plurality of transmission modes, a peak to average power ratio of said first digital baseband signal in a second transmission mode of said plurality of transmission modes is higher,
said first amplification portion receives said first digital baseband signal in said first transmission mode and said first digital baseband signal in said second transmission mode,
said control unit varies said first gain between a first lower limit value and a first upper limit value in said first transmission mode and varies said first gain between a second lower limit value and a second upper limit value in said second transmission mode,
said first lower limit value is greater than said second lower limit value, and
said first upper limit value is greater than said second upper limit value.

6. The semiconductor device according to claim 5, wherein
said first lower limit value is equal to or greater than said second upper limit value.

7. The semiconductor device according to claim 1, further comprising a local oscillation circuit for generating said local oscillation signal, wherein
said control unit further adjusts magnitude of a drive current to be supplied to said local oscillation circuit in accordance with said transmission mode.

8. The semiconductor device according to claim 1, wherein
said first digital baseband signal includes an in-phase component signal and a quadrature component signal,
said first amplification portion amplifies each of said in-phase component signal and said quadrature component signal with said first gain,
said analog baseband signal includes an in-phase component signal and a quadrature component signal,
said semiconductor device further comprises a frequency division circuit receiving said local oscillation signal and generating first and second local oscillation signals different from each other in phase by 90 degrees,
said modulation portion generates said transmission signal by modulating said first and second local oscillation signals with said in-phase component signal and said quadrature component signal of said analog baseband signal, and
said control unit further adjusts magnitude of a drive current to be supplied to said frequency division circuit in accordance with said transmission mode.

9. The semiconductor device according to claim 1, wherein
said plurality of transmission modes are transmission modes different from one another in at least any one of a modulation scheme, a multiplexing scheme, and a multiple access scheme.

10. A semiconductor device, comprising:
a first amplification portion receiving a first digital baseband signal and generating a second digital baseband signal by amplifying said first digital baseband signal with a first gain, the first gain being variable;
a digital-to-analog conversion portion for converting said second digital baseband signal generated by said first amplification portion into an analog baseband signal;
a modulation portion for generating a transmission signal by modulating a local oscillation signal with said analog baseband signal;
a second amplification portion for amplifying said transmission signal with a variable second gain; and
a control unit for adjusting said first gain in accordance with at least any one of a modulation scheme, a multiplexing scheme, and a multiple access scheme employed in generation of said first digital baseband signal through baseband processing from data to be transmitted.

11. A semiconductor device, comprising:
a first amplification portion receiving a first digital baseband signal and generating a second digital baseband signal by amplifying said first digital baseband signal with a first gain;
a digital-to-analog conversion portion for converting said second digital baseband signal generated by said first amplification portion into an analog baseband signal;
a modulation portion for generating a transmission signal by modulating a local oscillation signal with said analog baseband signal;
a second amplification portion for amplifying said transmission signal with a variable second gain; and
a control unit receiving a control signal for adjusting transmission electric power when said transmission signal is transmitted by radio and adjusting said first and second gains in accordance with the control signal.

12. The semiconductor device according to claim 11, further comprising a reception circuit externally receiving a reception signal and generating a data signal lower in frequency than said reception signal based on said reception signal, wherein
said control signal is a signal based on information included in said data signal.

13. The semiconductor device according to claim 12, wherein
said reception circuit supplies said data signal to a baseband processing circuit, and
said control unit receives said control signal from said baseband processing circuit

14. The semiconductor device according to claim 12, wherein
said transmission signal is transmitted to a power amplifier, and
said control unit further receives a detection signal resulting from detection of output from said power amplifier and adjusts said first and second gains also in accordance with the detection signal.

15. The semiconductor device according to claim 11, wherein
said control unit adjusts said first and second gains such that a minimum amount of change in said first gain is less than a minimum amount of change in said second gain.
